(19) United States
(12) Patent Application Publication
(10) Pub. No.: US 2026/0145974 A1
(43) Pub. Date: May 28, 2026

(54) Temporary Supplemental Disinfection Cart for Premises Water Supply Systems

(71) Applicant: IWC Innovations, LLC, Indianapolis, IN (US)

(72) Inventor: Brian E. Waymire, Greenwood, IN (US)

(21) Appl. No.: 19/386,358

(22) Filed: Nov. 12, 2025

Related U.S. Application Data
(60) Provisional application No. 63/725,278, filed on Nov. 26, 2024.

(51) Int. Cl. C02F 1/68; C02F 1/72

(52) U.S. Cl. CPC C02F 1/68; C02F 1/72; C02F 2201/002; C02F 2201/008; C02F 2209/008; C02F 2209/04; C02F 2209/06; C02F 2209/29; C02F 2303/04; C02F 2305/023; C02F 2307/14

(57) ABSTRACT

A portable, temporary supplemental disinfection system is provided that can be temporarily integrated into an existing water system. The disinfection system includes a delivery system for controlled delivering of a water treatment agent, such as an advanced oxidation processes (AOP) agent, to the premises water system. A disinfection monitoring module is connected to the water system downstream of the introduction of the AOP agent and includes at least sensors to measure oxidation reduction potential (ORP)(mV) and pH, and a free chlorine analyzer (ppm). A control module controls the operation of the delivery system, reads the data from the water quality sensors and provides alerts and maintenance notifications to water-management personnel. All of these components are mounted on a rigid panel that is configured to be supported and transported by a conventional hand cart. The control module can include a wireless modem to transmit between the control module and off-site water-management personnel responsible for monitoring and controlling the operation of the portable, temporary supplemental disinfection system.

### PRIORITY CLAIM

This application claims priority to U.S. Provisional Application No. 63/725,278, filed on Nov. 26, 2024, the entire disclosure of which is incorporated herein by reference.

### BACKGROUND

The present disclosure concerns systems for ensuring the safety and purity of drinking water on-demand.

In general, public drinking water supplies in developed countries are treated according to government standards that make the water safe for intended use. In the United States, potable water supplied by community water systems is treated to National Primary Drinking Water Standards, a set of requirements developed by the United States Environmental Protection Agency (USEPA) under authority of the Safe Drinking Water Act (SDWA). Most regulatory mandates regarding drinking water have focused primarily on the quality of the water at the point it leaves the treatment plant. However, it is increasingly recognized that the quality of regulation-compliant drinking water can deteriorate after it enters the distribution system, namely the series of pipes that transport water from the treatment plant to the customer.

Conventional commercial and residential water treatment systems can be effective to address contaminants in the drinking water at the point-of-access, such as the faucet or refrigerator water tap. For instance, water softeners remove minerals, such as calcium and magnesium, from water at the point-of-entry. Filter-based water treatment systems can be provided at the point-of-use or point-of-entry and can filter various chemicals and biological contaminants, depending on the nature of the filters in the system. Microfiltration, ultrafiltration, nanofiltration and reverse osmosis systems can remove parasites, some bacteria and some viruses. Ultraviolet treatment systems, with prefiltration, can also remove parasites, some bacteria and some viruses. A combination of treatment elements at the point-of-entry and at the points-of-use can provide effective treatment of the incoming drinking water during steady, normal-use conditions.

However, water quality issues in premises plumbing of residential and commercial settings can arise suddenly due to environmental impacts, infrastructure failures, or contamination events. Thus, while the conventional water treatment system is effective for normal-use conditions, such systems are not equipped to respond rapidly to these intermittent and unpredictable challenges. Premises or domestic water systems are characterized by longer water-residence times, more stagnation, lower flow conditions, higher surface area to volume ratio (owing to relatively lengthy sections of small-diameter pipe), lower (if any) disinfectant residual and higher water temperatures. These distinctive characteristics of premises water systems create a unique ecological niche and home to a robust microbial ecology. However, most premises water systems do not include water treatment capabilities that are scaled to effectively handle biologic contaminants, such as bacteria and viruses.

There is a need for an on-demand, scalable solution to enhance water safety temporarily without requiring permanent alterations to existing water supply systems.

### SUMMARY

A portable, temporary supplemental disinfection system is provided that can be temporarily integrated into an existing water system. The disinfection system includes a delivery system for delivering an advanced oxidation processes (AOP) agent, or other agent for water treatment, to the premises water system, and is configurable based on the specific contaminant load and water flow requirements of the facility being treated. The system further includes a disinfection monitoring module that includes a plurality of water quality sensors, in particular probes or sensors to measure oxidation reduction potential (ORP)(mV) and pH, and a free chlorine analyzer (ppm). A control module controls the operation of the delivery system, reads the data from the water quality sensors and provides alerts and maintenance notifications to water-management personnel. All of these components are mounted on a rigid panel that is configured to be supported and transported by a conventional hand cart. The control module can include a wireless modem to transmit between the control module and off-site water-management personnel responsible for monitoring and controlling the operation of the portable, temporary supplemental disinfection system.

The portable, temporary supplemental disinfection system is transported to the point of entry from the municipal water supply to the premises water system. The delivery system is connected to the premises water system downstream and adjacent to the backflow preventer and the diluted AOP is pumped from the reservoir to the premises water system in a predetermined amount and at a predetermined flow rate. The disinfection monitoring module is connected to the premises water system downstream from the location where the AOP is introduced into the system. The disinfection monitoring module generates data from the sensors that is compared to predetermined thresholds to evaluate the efficacy of the water treatment. Adjustments to the quantity and rate of introduction of the AOP agent can be made in response to the sensor data.

### BRIEF DESCRIPTION OF THE DRAWINGS

FIG. 1 is a front view of a portable, temporary supplemental disinfection system according to one embodiment of the present disclosure.

FIG. 2 is a side view of the system shown in FIG. 1.

FIGS. 3A-3B are side and rear views of the system of FIG. 1 carried by a hand cart.

FIG. 4 is a schematic representation of the portable, temporary supplemental disinfection system of FIGS. 1-3 connected to a premises water system.

### DETAILED DESCRIPTION

In response to the growing need for improved water quality and safety in commercial and residential settings, a temporary supplemental disinfection system and method is provided that introduces an advanced oxidation processes agent into the domestic water system at the point-of-entry to the building/house water system to mitigate microbial growth concentrations within the system.

The first component of the system and method is an Advanced Oxidation Processes, or AOP, agent. AOPs are a set of chemical treatment agents specifically designed to remove organic and pathogens from water by oxidation through reactions with hydroxyl radicals. This technology is capable of degrading a wide range of contaminants, including those that are typically tolerant to other treatment methods.

HydroTreat™ AOP provided by IWC Innovations, LLC, is an AOP that includes an advanced oxidation formula of oxygen-chelated minerals stabilized in a water-based solution. Water treatment oxidants attract electrons and initiate oxidation. When oxidation reaction takes place the chemistry of the substance or microorganism that loses the electron is disrupted and can no longer exist in its previous form. AOPs are chemical treatment procedures that catalyze oxidants and intensify the results. The catalysts are a source of energy that helps the reagent act faster, stronger, and amplify the chain reaction.

HydroTreat™ AOP is a mixture of chlorine (12.5% sodium hypochlorite) and a proprietary oxidation catalyst (JC9400) from JenFitch, Inc., calibrated to remove biofilm and/or inactivate biofilm-associated pathogens. It is approved for treatment of drinking water by the U.S. Environmental Protection Agency, National Sanitation Foundation, American National Standards Institute and Standards Council of Canada (NSF/ANSI/CAN). Details of the chemical composition of this AOP and discussion of methods for the use of the AOP to remove biofilms in a premises water system are disclosed in U.S. Pat. No. 10,696,572, entitled “Methods for Eradicating Biofilms From Plumbing Systems”, which issued on Jun. 30, 2020, the entire disclosure of which is incorporated herein by reference. Among current known oxygen-based reagents, HydroTreat™ AOP provides the highest electrochemical potential, which is the active energy to initiate an oxidation reaction, as summarized in Table 1.

TABLE 1
Electrochemical Potential of Oxygen-Based Reagents

| | Chemical | Electrochemical |
|---|---|---|
| Reagent | Formula | Potential (Volts) |
| Fluorine | F₂ | 3.06 |
| HydroTreat ™ AOP | MₓO_{y}Cl₂ | 2.80-2.90 |
| Hydroxyl radical | OH⁻ | 2.80 |
| Oxygen ion | O⁻ | 2.42 |
| Ozone | O₃ | 2.07 |
| Hydrogen peroxide | H₂O₂ | 1.78 |
| Hydroperoxy radical | HO₂ | 1.70 |
| Chlorine dioxide | ClO₂ | 1.57 |
| Hypochlorous gas | HOCl | 1.49 |
| Chlorine gas | Cl₂ | 1.36 |
| Oxygen, atmospheric | O₂ | 1.23 |
| Hypochlorite ion | OCl⁻ | 0.94 |
| Sodium hypochlorite | NaOCl | 0.94 |
| Hydroperoxide anion | HO₂⁻ | −0.88 |
| Superoxide radical | O₂⁻ | −2.40 |

Aquatic bacteria represent the most common and problematic waterborne pathogen for causing disease among organisms found in premises water systems. In time-kill studies, HydroTreat™ AOP has demonstrated significant bactericidal activity at just 1 ppm. The results indicated a log 10 reduction of 0.59 to 1.47 in bacterial counts within initial contact and even more activity observed after the first 2 minutes of exposure to the disinfectant (see Table 2 below). After 30 seconds of contact time, the effect is indistinguishable. This rapid action was sustained over the testing period, with no detectable bacterial regrowth observed after 5 minutes. The disinfectant achieved a 99.999% reduction in the populations of each Gram-negative bacteria and 76.363% reduction among the well-known halotolerant non-Tuberculous Mycobacteria (NTM) bacteria tested, confirming its broad-spectrum efficacy. An independent time-kill study demonstrates the potential of HydroTreat™ AOP for effective microbial control in healthcare and other settings requiring stringent hygiene practices.

TABLE 2
HydroTreat ™ (1 ppm) Time-Kill Results

| | | | 0 | 30 | | |
|---|---|---|---|---|---|---|
| | | | seconds | seconds | 2 minutes | 5 minutes |
| Challenge | | Population | Contact | Contact | Contact | Contact |
| Organism | Units | Control | Time | Time | Time | Time |
| Legionella | CFU/mL | 3.6 × 10⁸ | 1.2 × 10⁵ | 8.1 × 10⁴ | 1.5 × 10¹ | <1.0 × 10¹ |
| pneumophila | Log | 6.5563 | 5.0792 | 4.9085 | 1.1761 | <1.0000 |
| ATCC 33152 | CFU/mL | | | | | |
| | % | | 96.666667 | 97.750000 | 99.999583 | >99.999722 |
| | reduction | | | | | |
| | Log₁₀ | | 1.4771 | 1.6478 | 5.3802 | >5.5563 |
| | reduction | | | | | |
| Pseudomonas | CFU/mL | 1.1 × 10⁸ | 9.9 × 10⁴ | <1.0 × 10¹ | <1.0 × 10¹ | <1.0 × 10¹ |
| aeruginosa | Log | 6.0414 | 4.9956 | <1.0000 | <1.0000 | <1.0000 |
| ATCC 27853 | CFU/mL | | | | | |
| | % | | 91.000000 | >99.999091 | >99.999091 | >99.999091 |
| | reduction | | | | | |
| | Log₁₀ | | 1.0458 | >5.0414 | >5.0414 | >5.0414 |
| | reduction | | | | | |
| Mycobacterium | CFU/mL | 1.1 × 10⁷ | 2.8 × 10⁶ | 2.5 × 10⁶ | 2.6 × 10⁶ | 2.6 × 10⁶ |
| terrae | Log | 7.0414 | 6.4472 | 6.3979 | 6.4150 | 6.4150 |
| ATCC 15755 | CFU/mL | | | | | |
| | % | | 74.545455 | 77.272727 | 76.363636 | 76.363636 |
| | reduction | | | | | |
| | Log₁₀ | | 0.5942 | 0.6435 | 0.6264 | 0.6264 |
| | reduction | | | | | |

The present disclosure provides a method to mitigate microbial growth in a domestic or premises water system in which a temporary supplemental disinfection system is deployed over a predefined period, such as a 60-day period. The method involves the controlled addition of the disinfectant HydroTreat™ AOP to the water supply to actively reduce and manage bacteria levels. In a specific embodiment, the 60-day deployment period is effective at eradicating Legionella bacteria in the premises water system. Regular monitoring of water quality and microbial testing are conducted throughout this 60-day period to track the effectiveness of the treatment and ensure that microbial concentrations remain below acceptable thresholds. This short-term intervention serves as an effective strategy to quickly improve water safety and hygiene without permanent alterations to the water system infrastructure. An embodiment of the temporary supplemental disinfection system disclosed herein is optimized to deliver HydroTreat™ AOP agent, it could be adapted to other acceptable alternative agents for the control of microbial growth in a premise water system

The second component of the present system is a temporary supplemental disinfection cart configured primarily for the controlled administration of the HydroTreat™ AOP into the premises water system. The HydroTreat™ AOP disinfection cart, or HDC system, provides a structured approach to both reactive and proactive water system management. The HDC system disclosed herein allows facility managers to handle potential health risks associated with waterborne pathogens efficiently and stay compliant with health regulations. By offering various treatment durations and proactive management, the HDC system caters to diverse needs and provides flexibility in managing and prioritizing water safety in different environments.

The HDC system is a portable unit that can be temporarily integrated into an existing water supply without significant infrastructure changes to the building water system. The primary components of the portable HDC system are:

1) Modular Oxidation Unit: provides a delivery module for delivering the AOP to the premises water system, and is configurable based on the specific contaminant load and water flow requirements of the facility being treated. The Modular Oxidation Unit can be remotely controlled by specialists.

2) Disinfection Monitoring Module: Equipped with water quality probes or sensors to measure ORP (mV), pH, and a free chlorine analyzer (ppm).

3) Control System: A smart control unit monitors water quality parameters in real-time and adjusts the treatment intensity accordingly. It also provides alerts and maintenance notifications to building managers.

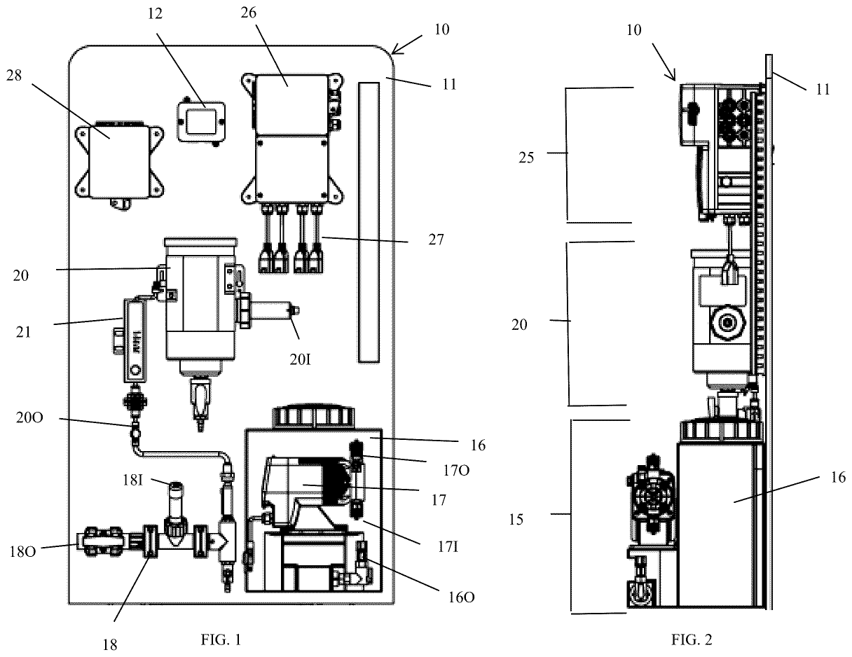

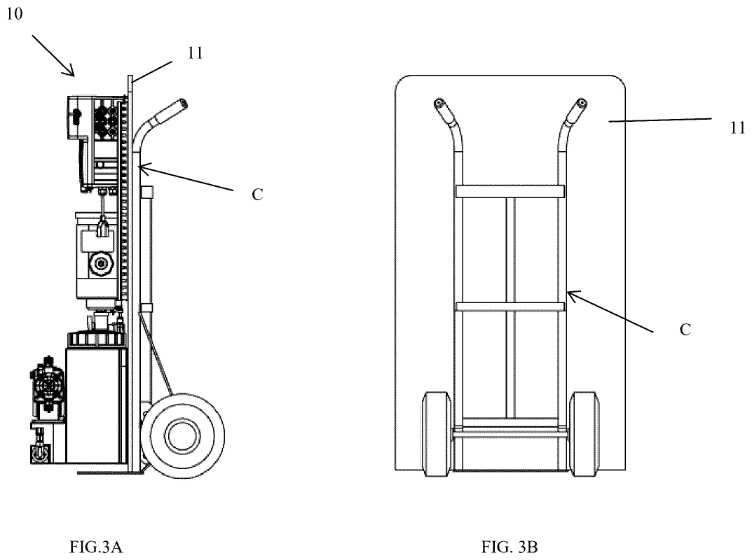

As shown in the FIGS. 1-2, the components of the HDC system 10 are mounted on a rigid support panel 11. The panel can be provided with bracing to help support the weight of the components when the panel is standing vertically adjacent to the premises water system. In particular, the HDC system 10 and panel 11 are configured to be supported on a wheeled hand cart, such as the cart C shown in FIGS. 3A-3B. The panel can include mounting brackets for engaging the hand cart C, or the components of the hand cart can be integrated into the panel 11 so that the HDC system 10 is mobile and able to be stationed for connection to the premises water system.

The system includes a power supply 12 to provide electrical power to the components of the system. The three system components of the system are stacked on the support panel. The modular oxidation unit 15 is at the base of the panel since it includes a reservoir 16 for the HydroTreat™ AOP and a pump 17 for delivering the HydroTreat™ AOP to the existing water system. The reservoir is sized to contain a composition including diluted HydroTreat™ AOP in sufficient quantity for introduction of an amount of the HydroTreat™ AOP into the premises water supply sufficient to disinfect the premises water system. In a specific embodiment, the reservoir is sized to contain 5 gallons of liquid. The pump inlet 17I is connected to the reservoir outlet 16O by a flexible hose (not shown for clarity). The pump outlet 17O is connected to the inlet 18I of a flow meter 18 by a flexible hose (again, not shown for clarity). The flow meter 18 can provide data indicative of the flow rate of the HydroTreat™ AOP from the reservoir. The outlet 18O of the flow meter 18 includes a hose fitting for connection to a hose for connection to the premises water system, as described herein. The pump 17 is controllable to control the activation time and amount of HydroTreat™ AOP dispensed from the reservoir 16. In one specific embodiment, the pump 17 is a MicroLinx Series L pump of Advantage Controls, Inc.

The disinfection monitoring module 20 is connected to the existing water system and includes components or sensors for analyzing the water quality during the treatment protocol. The inlet 20I of the monitoring module 20 includes a hose fitting for connection to a hose connected to the premises water system downstream of the point of entry of the HydroTreat™ AOP to the system, namely downstream of the connection of the outlet 18O to the premises water system. The outlet 20O feeds the water back to the flow meter 18 through a pressure valve 21. The disinfection monitoring module 20 includes a plurality of water quality probes or sensors that measure characteristics of the water while it is being treated. In one embodiment, the module includes probes or sensors to measure water temperature, ORP and pH, as well as a free chlorine analyzer. It is known that the ORP and pH of the water can affect the ability of the HydroTreat™ AOP to adequately treat the water. ORP is a measure of the water's ability to oxidize, which in turn is a measure of the potential effectiveness of the chlorine compositions in the HydroTreat™ AOP. The module 20 generates data that is evaluated automatically and/or off-site by qualified water-management personnel. The data read by the module can be compared against preset thresholds and historical trends, and can generate alerts that warrant investigation of the HDC system 10 and premises water supply, such as chlorine levels below disinfection standards or critical ORP deviations. In certain embodiments, the alert thresholds can be 650-850 mV for ORP, 6.5-8.5 for pH and 0.5-4.0 mg/L for free chlorine content.

The control system 25 is mounted at the top of the panel 11, particularly to provide access to a controller 26. The controller is electrically connected by a plurality of cables 27 to the components of the system, namely the modular oxidation unit 15, the pump 17, the flow meter 18 and the disinfection monitoring module 20, to control the operation of these components. The control system 25 includes a modem 28 connected to the controller 26 and configured for communication to an off-site administrator who can control the operation of the modular oxidation unit 15 through the controller 26. The modem can also transmit flow data generated by the flow meter, testing information, generated by the disinfection monitoring module 20 and by the controller 26 to the off-site administrator who can monitor the progress of the disinfection treatment and determine whether the operation of the oxidation unit 15 needs to be modified. The controller 26 polls the sensors in the disinfection monitoring module 20 at defined time intervals, such as every 5 minute, every 15 minutes or hourly, to generate data for analysis and for generating the historical trend data for evaluation by the water-management personnel.

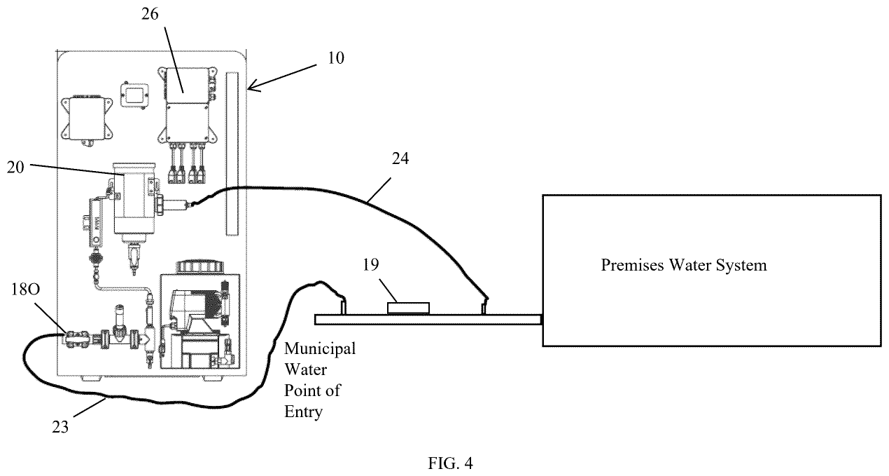

The HDC system 10 connects to the bypass port of the domestic water system downstream of the backflow preventer at the point of entry from the municipal provider. The connection can be a conventional flexible hose 23 connected to the outlet 18O of the modular oxidation unit 15 using a standard ½″ ball valve, as shown in FIG. 4. This connection point ensures that the HydroTreat™ AOP passes through the entire premises water system. A secondary flexible hose 24 can be connected to a takeoff point some distance downstream of the oxidation unit connection, and connected to the disinfection monitoring module 20 of the system 10 to feed downstream water back to the module, as shown in the representation in FIG. 4. The secondary hose 24 can tap into the premises water system sufficiently far downstream to ensure that the analysis by the water quality probes acquires appropriate, meaningful data (pH, ORP, free chlorine). Alternatively, the sensors or probes of the disinfection monitoring module 20 can be independent of the cart for the HDC system 10 and significantly downstream of the point of entry where the HydroTreat™ AOP is introduced. In this alternative, the sensors can be provided with wireless communication to transmit data to the disinfection monitoring module 20 or directly to the controller 26.

In one embodiment, the flow meter 18 of the modular oxidation unit 15 can include an ultrasonic flow transducer 19 that measures the flow rate of the water through the premises water system in a non-invasive manner, thereby eliminating the need for modifications to the pipes of the premises water supply. As shown in FIG. 4, the ultrasonic flow transducer 19 is mounted directly to the inlet pipe for the premises water system. The flow transducer 19 can be well downstream from the HDC system 10 and from the secondary hose 24 connection for the disinfection monitoring module 20.

The transducer can be connected to the controller 26, either directly or wirelessly, to transmit flow data to the control system 25. In one specific embodiment, the transducer 19 is a U1000 V2 ultrasonic flow meter provided by Georg Fischer Ltd. The flow rate measured by the flow meter 18 is used to modulate the operation of the pump 17 to control the rate of injection of the HydroTreat™ AOP from the reservoir 16 into the water supply. By precisely matching the disinfectant dosing rate to the current facility water demand, as determined by the flow measurements, the system 10 ensures consistent disinfection efficacy while minimizing chemical usage. This flow-based dosing approach enhances the efficiency and responsiveness of the supplemental disinfection system 10, adapting seamlessly to variations in water usage patterns within the facility.

Upon activation of the HDC system, a precise procedure is followed involving the dilution of an appropriate dose of HydroTreat™ AOP depending on the use case of the facility. In a typical use case, only 11 fluid ounces of HydroTreat™ AOP is diluted in the 5-gallon reservoir of water, although different quantities of diluted HydroTreat™ AOP may be required for a particular premises water system. This dilution process is a critical daily task that is meticulously carried out on-site by water-management personnel. The reservoir level can be monitored remotely by a sensor connected to the controller 26, but should preferably be checked often by the water-management personnel. The regularity and precision of this task ensures that the water treatment process remains consistent and effective, contributing to the overall maintenance and safety of the domestic water system. This systematic approach to water treatment through the HDC system demonstrates a structured effort to ensure water quality and safety across the facility.

The HDC system 10 can be activated or deactivated as needed, providing temporary supplemental disinfection without altering the permanent water supply infrastructure. The portability of the HDC system 10 disclosed herein allows for targeted application exactly where and when it's needed, accommodating variable flow rates and water usage patterns without permanent infrastructure modifications. This adaptability makes it ideal for responding to acute contamination events or during temporary increases in risk, such as seasonal changes or after maintenance work. Such systems can be quickly deployed and removed, providing a practical solution that adjusts to the specific needs and circumstances of the facility, ensuring effective pathogen control with minimal disruption to normal operations. The HDC system 10 is suitable for various use cases to address microbial growth within a premises water system.

### Case Investigation

In the event of a Legionella outbreak or facility case investigation by the Department of Health (DOH), an HDC disinfection cart system 10 can provide supplemental disinfection capabilities to help control and limit the spread of microbial growth risk and reduce the time a facility is under DOH observation. The system 10 will even extend the protection of the water system after an acute chemical sanitization remediation treatment.

### Routine Monitoring

During preventative routine monitoring, testing results can sometimes show low growth concentrations (<1 CFU/mL), but can be widespread in nature. If Legionella bacteria are detected in a water system, an HDC system 10 can be deployed quickly to address the risk. Reducing this risk is crucial in preventing the spread of Legionnaires' disease, particularly in settings where vulnerable populations are present, such as hospitals, nursing homes, and other healthcare facilities.

### Maintenance and Preventative Treatment

For facilities that have complex water systems, regular maintenance on the water system is usually expected. Maintenance events can cause disturbances (e.g. dislodging of biofilm and sediment) which can introduce tremendous Legionella exposure risk to the facility. The same risk can be observed with disturbance events that take place outside of the facility where major construction and water shutoff events can introduce additional exposure risk to the facility. Incorporating an HDC system 10 into the maintenance operation can help keep the system safe during these events and then be easily removed once the maintenance or preventative treatment is completed. It's a proactive approach to disinfect parts of the system that might be at risk of microbial growth due to infrequent use or other risk factors.

### Vacant Buildings or Low Utilization Areas

Facilities or areas that have been unoccupied for extended periods of time (weeks or months) typically have low utilization of water. Because the water in the premises water system is stagnant, this allows waterborne pathogens to establish biofilms in the plumbing system, which can provide many growth advantages for these pathogens and be challenging to remove. This also means that these areas are without adequate levels of residual disinfectant (e.g. chlorine) from the municipal water supply to mitigate microbial growth, as the concentration of the residual disinfectant wanes over time. An HDC system 10 will provide supplemental disinfectant to facilities such as this to address the challenges of microbial growth in unoccupied spaces.

### New Construction

Using an HDC system 10 for supplemental disinfection in a new construction building prior to occupancy is highly beneficial for ensuring water safety by mitigating opportunities for colonization. In newly constructed buildings, domestic water systems may harbor bacteria and pathogens due to stagnant water or debris during the construction phase. Implementing a portable disinfection system allows for the thorough sanitization of the water supply before residents move in, mitigating potential health risks. This preemptive approach ensures that all waterborne contaminants are effectively neutralized, establishing a baseline of water quality and safety. Additionally, the flexibility of a portable system allows for easy setup and removal, making it an efficient and practical choice for builders and property managers to maintain standards without delaying occupancy.

### Disaster Recovery

Installing a temporary supplemental disinfection system can be highly beneficial for a facility undergoing disaster recovery after an inclement weather event. Such events, like hurricanes, floods, earthquakes, or tornadoes, often compromise water systems either through direct damage to infrastructure or through contamination from environmental runoff and debris. An HDC system 10 can be installed in any and all building water systems to ensure the rapid and effective elimination of pathogens and pollutants, safeguarding public health during a critical period when the facility's main water treatment capabilities might be impaired or offline. This approach provides an essential stopgap, maintaining clean and safe water supply, which is crucial for hygiene, disease prevention, and the overall recovery process. Moreover, it helps the facility meet regulatory health standards and restore normal operations more swiftly and safely.

### Hot Water System

In hot water systems lacking recirculation, stagnant water coupled with lower temperatures can promote the growth of microbes due to plumbing design pitfalls, such as dead legs. These circumstances raise concerns about potential microbial growth in stagnant sections of the plumbing system, such as Legionella. A risk assessment will pinpoint the most vulnerable sections, prompting the deployment of a temporary supplemental HDC system. The HDC system 10, can be strategically installed at points prone to water stagnation to ensure comprehensive treatment takes place. In circumstances like this, introducing the HydroTreat™ AOP at the point of entry of the municipal water is not critical—the more critical factor is providing the HydroTreat™ AOP at the points of water stagnation. The HDC system effectively mitigates microbial growth, serving as a reliable interim solution until permanent system upgrades can be made.

Within a hot water system environment, the process of adding cold water to hot water for the purpose of optimizing conditions for water quality analyzers in the HDC system involves several key considerations. Water quality analyzers and sensors often have specific operational temperature ranges (max 104° F.). Hot water from the system often exceeds this limit, potentially damaging the equipment or skewing the results. By adding cold water, the temperature of the water entering the analyzer is adjusted to fall within the acceptable range, ensuring accurate readings and protecting the equipment.

To account for this engineering adjustment, and manage chemical injection in the plumbing system, the HDC system 10 allows for the addition of up to 1 ppm of HydroTreat™ AOP into the water line. This can then be diluted to 0.5 ppm by the time it reaches the faucets due to the 50/50 hot/cold water mixing controlled by the system. This setup ensures compliance with the Safe Drinking Water Act's requirement of less than 4.0 ppm and the manufacturer's recommended limits. The control system 25 can be reprogrammed, either on-site or remotely through the modem, to maintain chlorine levels between 0.4 ppm and 0.9 ppm to accommodate the propagation delay from the pump to the free chlorine probe, ensuring accurate dosing and preventing excess chemical feed. If this delay proves too long, the adjustments can be made to the flow meter to better regulate the chemical feed.

As described above, the control system 25 includes a modem 28 for wireless communication of data from the disinfection monitoring module 20 and instructions to the controller 26. The present HDC system 10 contemplates integrating with a remotely accessed computer, whether a desktop or laptop computer or a smart phone or tablet. The remote computer includes software that can receive and process the data generated by the monitoring module. The software can allow the water-management personnel to access the monitoring module data off-site and in real-time, and can compare readings against preset thresholds and historical trends stored in a memory of the computer. The software can be configured to generate alarms when unusual fluctuations arise or measured values are outside the acceptable range. The software also records all of the monitoring observations and can create a daily log summarizing the water quality status, the performance of the HDC system 10 and any modifications made by the water-management personnel to the operation of the HDC system, such as change in the amount of HydroTreat™ AOP introduced into the water system. The software can also be configured for self-checking to identify potential issues with the monitoring module 20, such as sensor drift, or with the control system 25, such as communication errors.

Testing of the HDC system is also a critical check on the performance of the system as well as the efficacy of the disinfection process. The testing follows the following exemplary protocol:

1. Baseline Testing: Conduct baseline water quality tests prior to the installation of the HDC system 10. This will establish the initial conditions of the water quality that may include parameters such as microbial content, pH, ORP, turbidity, free chlorine levels, and other relevant contaminants.

2. Installation Date: Install the HDC system 10 and commence operations.

3. Midpoint Testing (30 days post-installation):
Date: 30 days after the system installation.
Purpose: To assess the immediate impact of the disinfection system on water quality. This timeframe allows for observation of any initial fluctuations or improvements in water quality metrics.
Tests Conducted: Repeat the same tests as in the baseline testing to measure parameters like microbial reduction, pH balance, ORP levels, and chlorine content.
Analysis: Compare results with baseline data to determine any changes and adjustments needed in the system's operation.
Testing at 30 days serves to quickly identify and rectify any initial problems or inefficiencies in the system's performance. This early checkpoint helps in making necessary adjustments to the system operations or settings.

4. Endpoint Testing (60 days post-installation);
Date: 60 days after the system installation.
Purpose: To evaluate the long-term efficacy of the system and its stability over a longer period. This will help in understanding how well the system maintains water quality over time and any long-term impacts it may have.
Tests Conducted: Same as baseline and midpoint testing.
Analysis: Data collected will be used to assess the system's performance over an extended period, identifying any trends such as the increase in efficiency or potential issues that may require attention.
The 60-day test provides data on the system's ability to consistently maintain water quality over a period that is sufficient to observe potential cyclic changes due to varying consumption patterns, environmental influences, or mechanical performance of the system.

By setting the testing points at 30 and 60 days, data can be compared across three key points (baseline, midpoint, and endpoint). This comparison is crucial in understanding the trajectory of water quality improvement or decline, facilitating proactive management of the water disinfection system. Adhering to a structured testing schedule ensures compliance with health and safety standards and regulations, which may require periodic verification of water quality post-installation of disinfection systems.

The HDC system 10 contemplates introducing the HydroTreat™ AOP into the premises water system because this composition has been shown to be effective in eliminating pathogens, bacteria and viruses, and more significantly to be effective against Legionella bacteria which is a significant risk in building water systems. However, other advanced oxidation processes (AOP) agents can be supplied using the HDC system 10 described herein. Adjustments to the quantity and rate of introduction of the alternative AOP agent may be required. In that regard, software in the controller 26 or software in the remote controller can be configured to allow the water-management personnel to adjust the operation parameters and test condition thresholds accordingly. A database of known AOP agents can be provided with corresponding data for operating the components of the HDC system 10, wherein the water-management personnel can select the particular agent from a pull-down menu.

The HDC system 10 is shown being transported by a hand cart C in FIGS. 3A-3B. As noted, the mobility features can be integrated into the support panel 11. The support panel 11 can also be modified to allow the HDC system 10 to be self-standing at the premises site without the need for the hand cart. The components 15, 20, 25 of the HDC system 10 are mounted as compactly as possible on the support panel to facilitate transport and placement of the system on the premises.

What is claimed is:

1. A portable, temporary supplemental disinfection system for connection to a premises water system, comprising:
a rigid panel;
a delivery module mounted on the rigid panel and including;
a reservoir for containing a liquid composition for treating the premises water system;
a flow meter having an outlet liquid fitting for connection to a first hose connected to the premises water system; and
a pump connected between the reservoir and the flow meter for pumping the liquid composition to the premises water system;
a disinfection monitoring module mounted on the rigid panel and including;
an inlet liquid fitting for connection to a second hose connected to the premises water system;
an outlet connected to the flow meter; and
at least three water quality sensors including;
a sensor for measuring oxidation reduction potential of the water in the premises water system;
a sensor for measuring the pH of the water in the premises water system; and
a free chlorine analyzer for measuring the free chlorine in the premises water system; and
a control module mounted on the rigid panel including;
a controller connected to the pump for controlling the operation of the pump and connected to the disinfection monitoring module to receive data from the at least three sensors; and
a power supply connected to supply electrical power to the controller, the delivery system module and the disinfection monitoring module.

2. The portable, temporary supplemental disinfection system of claim 1, wherein the control module further includes a modem connected to the controller to wirelessly transmit information to the controller for controlling the operation of the pump and to wirelessly transmit data from the at least three water quality sensors.

3. The portable, temporary supplemental disinfection system of claim 1, further comprising a hand cart, wherein said rigid panel is configured to be supported and transported by said hand cart.

4. The portable, temporary supplemental disinfection system of claim 1, further comprising an ultrasonic flow transducer configured to be mounted on a pipe of the premises water system remote from said control module and configured for communicating flow data generated by said transducer to said controller.

5. The portable, temporary supplemental disinfection system of claim 1, wherein the reservoir is sized to contain 5 gallons of the liquid composition.

6. The portable, temporary supplemental disinfection system of claim 1, wherein the liquid composition includes an advanced oxidation processes (AOP) agent.

7. The portable, temporary supplemental disinfection system of claim 6, wherein the AOP agent is HydroTreat™.

8. The portable, temporary supplemental disinfection system of claim 1, wherein the controller is connected to the flowmeter to receive data indicative of the flow rate of the liquid composition pumped by the pump.

9. A method for temporary, supplemental treatment of microbial growth concentrations in a premises water supply comprising the steps of:
providing a portable, temporary supplemental disinfection system at the point of entry of municipal water to the premises water supply, the disinfection system having;
a delivery module including a reservoir containing a liquid composition for treating the premises water system, a flow meter having an outlet fitting for connection to a first hose connected to the premises water system, and a pump connected between the reservoir and the flow meter for pumping the liquid composition to the premises water system;
a disinfection monitoring module including an inlet fitting for connection to a second hose connected to the premises water system, an outlet connected to the flow meter, and at least three water quality sensors including a sensor for measuring oxidation reduction potential of the water in the premises water system, a sensor for measuring the pH of the water in the premises water system and a free chlorine analyzer for measuring the free chlorine in the premises water system;
temporarily connecting a first hose between the outlet fitting of the delivery module and the premises water system adjacent to and downstream of the flow limiter of a premises water system;
temporarily connecting a second hose between the inlet fitting of the disinfection monitoring module and the premises water system at a location downstream of the connection of the first hose;
operating the pump of the delivery module to deliver an amount of the liquid composition to the premises water system at periodic time intervals according to a predetermined program for treatment of the microbial growth in the premises water system;
periodically operating the disinfection monitoring module to generate data indicative of the water quality of water in the premises water system; and
upon completion of the predetermined program, disconnecting the first and second hoses from the premises water system and removing the portable, temporary supplemental disinfection system.

10. The method for temporary, supplemental treatment of microbial growth concentrations in a premises water supply of claim 9, wherein:
the portable, temporary supplemental disinfection system includes a control module connected to the delivery module and to the disinfection monitoring module, the control module configured and operable to;
control the operation of the pump according to the predetermined program; and
receive data from the disinfection monitoring module.

11. The method for temporary, supplemental treatment of microbial growth concentrations in a premises water supply of claim 10, wherein:
the control module includes a wireless transmitter; and
the step of periodically operating the disinfection monitoring module to generate data includes transmitting the data to a remote device.

12. The method for temporary, supplemental treatment of microbial growth concentrations in a premises water supply of claim 10, wherein:
the control module includes a wireless transmitter; and
the step of operating the pump of the delivery module according to a predetermined program includes;
receiving control instructions at said control module from a remote device via the wireless transmitter; and
modifying the predetermined program according to the control instructions.

13. The method for temporary, supplemental treatment of microbial growth concentrations in a premises water supply of claim 9, wherein the liquid composition includes an advanced oxidation processes (AOP) agent.

14. The method for temporary, supplemental treatment of microbial growth concentrations in a premises water supply of claim 13, wherein the AOP agent is HydroTreat™.
